(19) United States
(12) Patent Application Publication
(10) Pub. No.: US 2007/0162660 A1
(43) Pub. Date: Jul. 12, 2007

(54) Method, apparatus and computer system for independently updating a storage device of a computer system

(75) Inventors: Wah Yiu Kwong, Beaverton, OR (US); Hong W. Wong, Portland, OR (US); Hue V. Lam, Portland, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/302,573

(22) Filed: Dec. 13, 2005

(51) Int. Cl. G06F 13/38

(52) U.S. Cl. 710/62

(57) ABSTRACT

Some embodiments of a method, apparatus and computer system are described for independently updating a storage device of a computer system. The apparatus includes a bus conversion module or dedicated connector coupled to a multiplexer, wherein the multiplexer is coupled to a primary storage. In embodiments, the information in the primary storage device is updated with the information from a secondary storage coupled via the bus conversion module or dedicated connector. Other embodiments are described.

### BACKGROUND

1. Technical Field

Some embodiments of the invention generally relate to managing storage devices of computer systems. More specifically, some embodiments relate to updating the information on a storage device of a computer system independently of the computer system.

2. Discussion

In recent years, the management of computer systems, including personal computers (PCs), notebook or laptop computers, personal digital assistants (PDAs), personal entertainment devices and mobile telephones, among other electronic devices, has entailed certain management and/or maintenance requirements on manufacturers, vendors, and users. Computer systems have internal storage devices, upon which information, often in the form of software, is stored. The information is vulnerable to corruption and often subject to change as the software is updated or the user makes changes.

Conventionally, when managed on small or a large or multiple scales, the storage devices are updated by removing the storage device from the computer system and connecting it to a master device or mirror of the original installation or a previous version or backup to restore the software on the storage device. In some environments, however, such as health care or sales, mobile devices are designed with limited physical access to peripherals, that is, the storage device is not readily accessible for removal. Moreover, it is time consuming to remove the storage devices or to determine how to power up a computer system and update the storage device. Furthermore, removing and re-installing procedure may damage the storage device or the system if it is not handled with extreme care or conducted by trained operators.

Therefore, there is a need for a way to update or restore the storage device without removing it and without powering up the computer system within which the storage device is installed.

### BRIEF DESCRIPTION OF THE DRAWINGS

Various advantages of embodiments of the present invention will become apparent to one of ordinary skill in the art by reading the following specification and appended claims, and by referencing the following drawings, in which:

FIG. 1 illustrates a computer system with independent updating components according to some embodiments of the invention;

FIG. 2 illustrates a computer system with independent updating components according to some embodiments of the invention;

FIG. 3 illustrates examples of bus devices according to some embodiments of the invention; and

FIG. 4 illustrates a flowchart of the independent updating according to some embodiments of the invention.

### DETAILED DESCRIPTION

Reference is made to some embodiments of the invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims. Moreover, in the following detailed description of the invention, numerous specific details are set forth in order to provide a thorough understanding of the invention. However, the invention may be practiced without these specific details. In other instances, well-known methods, procedures, components and circuits have not been described in detail as not to unnecessarily obscure aspects of the invention.

Some embodiments of a method, apparatus and computer system are described for independently updating a storage device of a computer system. The apparatus includes a bus conversion module or dedicated connector coupled to a multiplexer, wherein the multiplexer is coupled to a primary storage device. In embodiments, the information in the primary storage device is updated with the information from a secondary storage device coupled via the bus conversion module or dedicated connector. Other embodiments are described, for example, using various types of bus devices to provide access to the secondary storage device.

Indeed, reference in the specification to an embodiment or some embodiments of the invention means that a particular feature, structure or characteristic described in connection with the embodiment is included in at least one embodiment of the invention. Thus, the appearances of the phrase “in some embodiments” or “according to some embodiments” appearing in various places throughout the specification are not necessarily all referring to the same embodiment.

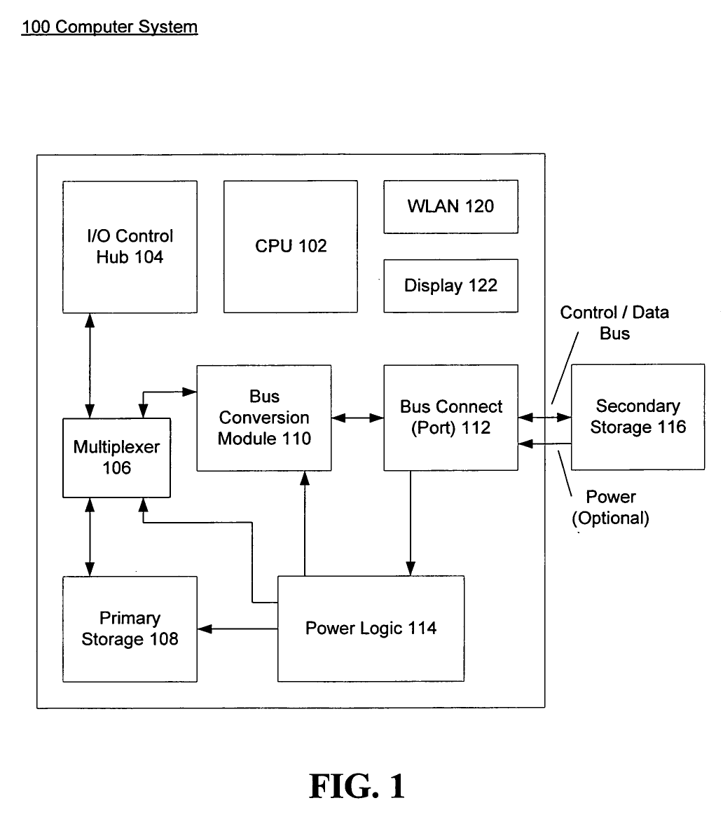

FIG. 1 illustrates a computer system 100 with independent updating components according to some embodiments of the invention. The computer system 100 includes a central processing unit (CPU) 102. In some embodiments, the CPU 102 may be a multiple core processor or microprocessor. The computer system 100 may also include an Input/Output (I/O) Control Hub (ICH) 104, such as in ICHx chipsets, manufactured by Intel® Corporation of Santa Clara, Calif., or other control logic. The ICH 104 may be coupled to various components (not all shown) to provide an interface for the control of the various components by instructions processed at least by the CPU 102.

Furthermore, the computer system 100 may include a wireless local area network (WLAN) module 120 and/or a display 122. In some embodiments of the invention, the WLAN 120 may provide network connectivity. In some embodiments, the display 122 may provide a representation of some of the information being processed by the computer system.

According to some embodiments of the invention, a multiplexer (MUX) 106 may be coupled to the hub 104 and the primary storage 108. In some embodiments, the multiplexer may have multiple inputs which are typically, but not exclusively, handled one at a time. In some embodiments, the MUX 106 may operate much like ‘call waiting’ on a telephone, where the MUX allows for the switching from one circuit to another.

In computer system 100, the MUX 106 may have two inputs, ICH 104 and a bus conversion module 110, described below. The connection shown to a power sharing (switching logic) 114, also described below, may be a control and/or power line to determine which input, either 104 or 110, the MUX 106 is switched to at a give time. However, in some embodiments of the invention, the logic 114 may be foremost a way to alternatively power the MUX 106, module 110, and other components required to transfer information from the secondary storage to the primary storage, such as, but not limited to, the primary storage 108 and secondary storage 116.

As described above and elsewhere here, the term ‘coupled’ is used to describe the connection between one or more components. According to some embodiments of the invention, the coupling may be direct or indirect, and one of ordinary skill in the relevant art would appreciate that either direct contact may not be required for electrical or signal connectivity. As such, the use of the term is not meant to imply that additional interfaces, buses, or devices are not used to couple the components of the computer system 100, nor the other systems and apparatuses described herein.

The bus conversion module 110, according to some embodiments, may be coupled to the MUX 106 and to a bus connect (port) 112. Furthermore, the bus conversion module 110 may also be connected to the power sharing (switching logic) 114. According to some embodiments of the invention, the power sharing (switching logic) 114, also known as power logic 114, may provide electrical power to the one or more devices to which it is coupled.

Furthermore, the bus connect (port) 112 may be controlled by the bus conversion module 110 and, in some embodiments, told to provide power to the MUX 106 and the primary storage 108, among other things. In some embodiments of the invention, the port 112 may be one of the following types: ExpressCard™, Universal Serial Bus (USB), Advanced Technology Attachment (ATA), Serial Advanced Technology Attachment (SATA or S-ATA), Small Computer Systems Interface (SCSI), IEEE-1394 (such as, but not limited to Firewire™, i.link™ or Lynx™), serial and/or parallel or similar bus types which one of ordinary skill in the art would recognize and appreciated in application, based at least on the teachings provided herein.

The bus conversion module 110 may provide control over the MUX 106 and via the bus connect (port) 112, access to a secondary storage 116, according to some embodiments of the invention. In some embodiments, the port 112 may provide power to the module 110, which in turns provides power to power logic 114.

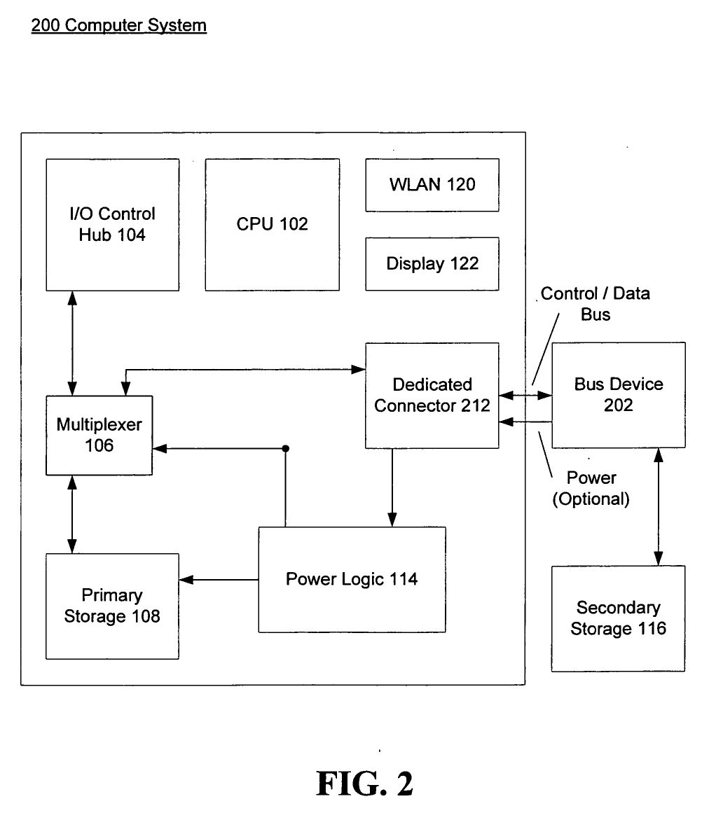

According to some embodiments of the invention, the port 112 may be coupled directly to the secondary storage 116. In some embodiments, however, the secondary storage 116 may be enclosed or coupled by a bus device (as shown in FIG. 2), which provides an interface between the port 112 and the storage 116 as well as power to the power sharing logic 114.

FIG. 2 illustrates a computer system 200 with independent updating components according to some embodiments of the invention. In some embodiments, the MUX 106 may be coupled to a dedicated connector 212. The connector 212 may include some of the functions of the module 110 and the port 112, but does not necessarily include all of the functions. Indeed, according to some embodiments of the invention, some functions of the module 110 may be performed by a bus device 202, which may be coupled to the connector 212 and which may thereafter couple the secondary storage 116 to the computer system 200.

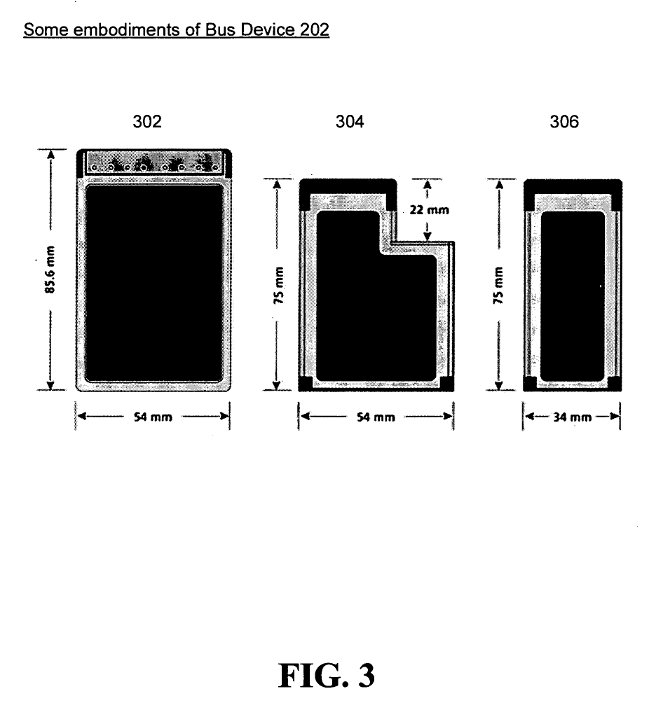

FIG. 3 illustrates examples of bus devices 202 according to some embodiments of the invention. In some embodiments, the bus device 202 may be of a propriety type and interface with a similarly propriety port 112 or connector 212. In some embodiments, the format or architecture used for the port and connector may be one of the following: ExpressCard™, Universal Serial Bus (USB), Advanced Technology Attachment (ATA), Serial Advanced Technology Attachment (SATA or S-ATA), Small Computer Systems Interface (SCSI), IEEE-1394 (such as, but not limited to Firewire™, i.link™ or Lynx™), serial and/or parallel or similar bus types which one of ordinary skill in the art would recognize and appreciated in application, based at least on the teachings provided herein.

As shown in FIG. 3, the devices 202 may resemble device 302, 304 or 306. Other device types may be used, as one of ordinary skill would appreciate, based at least on the teachings provided herein.

According to some embodiments of the invention, the computer system may include an apparatus. The apparatus may include a dedicated connector, such as dedicated connector 212, to couple a primary storage and a secondary storage to a bus, the dedicated connector may include a logic that identifies a secondary storage, wherein the secondary storage includes information to be transferred to a primary storage, receives a read/write operation targeted to the primary storage, and transmits the read/write operation and the information to the primary storage. External power can also be provided to the primary storage and the affected logics via the connector 212.

Furthermore, the apparatus may include a multiplexer, such as MUX 106, to couple the primary storage to the dedicated connector. In some embodiments, the dedicated connector may include a bus conversion module to perform the logic.

In some embodiments of the invention, the apparatus may be incorporated into a computer system, such as, but not limited to computer systems 100 and 200, and may include an input/output control hub to at least handle input and output operations of the computer system, a multiplexer to couple a dedicated connector and the input/output control hub to a primary storage, wherein the dedicated connector includes a logic that identifies a secondary storage, wherein the secondary storage includes information to be transferred to a primary storage, receives a read/write operation targeted to the primary storage, and transmits the read/write operation and the information to the primary storage.

In some embodiments, the logic may be implemented in hardware and/or in software, as well as partially in both, as one of ordinary skill in the relevant art(s) would appreciate based at least on the teachings provided herein.

As described above, the ICH may be inactive, or may otherwise be de-selected from the primary storage device, which is atypical of conventional computer systems, where the ICH provides management and control functions for the components on the bus(es). Furthermore, the computer system may be configured such that the dedicated connector may include a bus conversion module to perform the logic. In some embodiments, the computer system may be turned off, as is described elsewhere herein, such as in a batch update process or system software install process, and the power to operate the dedicated connector and the multiplexer may be transferred from a bus device to the dedicated connector.

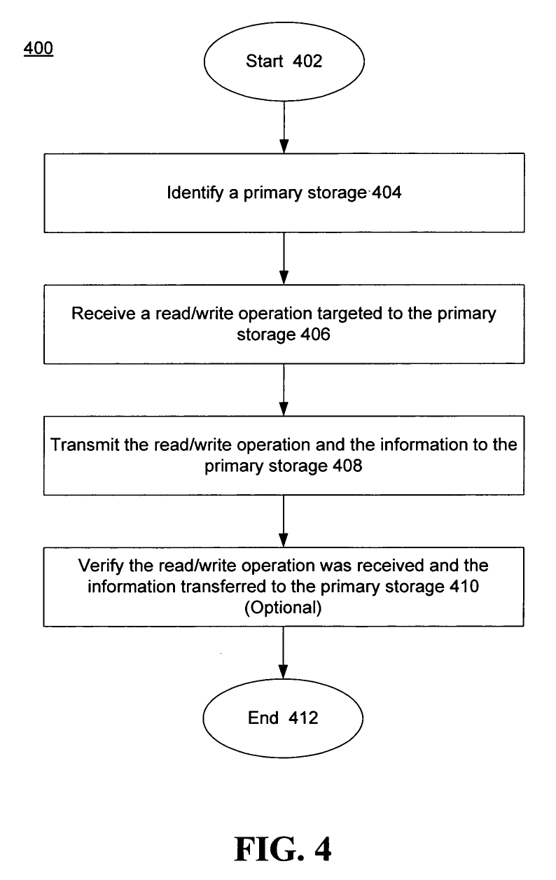

FIG. 4 illustrates a flowchart 400 of the independent updating according to some embodiments of the invention. In some embodiments of the invention, the operation of the invention may begin at 402 and proceed to 404, where it may identify a primary storage, where the primary storage is to receive information to be transferred from a secondary storage. The operation may then proceed to 406, where it may receive a read/write operation targeted to the primary storage. In some embodiments, the operation may then proceed to 408, where it may transmit the read/write operation and the information to the primary storage.

In some embodiments of the invention, the operation may optionally proceed to 410 and verify the read/write operation was received and the information transferred to the primary storage. The operation then ends at 412, where it may be repeated in whole or in part, as one of ordinary skill in the relevant art would appreciate based at least on the teachings provided herein. In some embodiments of the invention, the operation may, at 404, include the further operations of: activating a dedicated connector with a bus device, activating a multiplexer to select the primary storage, and reporting the selection of the primary storage to the dedicated connector.

In some embodiments of the invention, the operation may, at 406 and 408, include the further operations of: activating the secondary storage a bus device, determining the information to transmit to the primary storage, and constructing a read/write operation to transfer the information to the primary storage.

Embodiments of the present invention may be described in sufficient detail to enable those skilled in the art to practice the invention. Other embodiments may be utilized, and structural, logical, and intellectual changes may be made without departing from the scope of the present invention. Moreover, it is to be understood that various embodiments of the invention, although different, are not necessarily mutually exclusive. For example, a particular feature, structure, or characteristic described in one embodiment may be included within other embodiments. Those skilled in the art can appreciate from the foregoing description that the techniques of the embodiments of the invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A computer system comprising:
an input/output control hub to at least handle input and output operations of the computer system;
a multiplexer to couple a dedicated connector and the input/output control hub to a primary storage, wherein the dedicated connector includes a logic that identifies a secondary storage, wherein the secondary storage includes information to be transferred to a primary storage, receives a read/write operation targeted to the primary storage, and transmits the read/write operation and the information to the primary storage.

2. The computer system of claim 1, wherein the input/output control hub is inactive.

3. The computer system of claim 1, wherein the dedicated connector includes a bus conversion module to perform the logic.

4. The computer system of claim 1, wherein power to operate the dedicated connector and the multiplexer is transferred from a bus device to the dedicated connector.

5. The computer system of claim 4, wherein the bus device includes the secondary storage.

6. The computer system of claim 4, wherein the bus device employs at least one of ExpressCard™, Universal Serial Bus (USB), Advanced Technology Attachment (ATA), Serial Advanced Technology Attachment (SATA or S-ATA), Small Computer Systems Interface (SCSI), IEEE-1394 (such as, but not limited to Firewire™, i.link™ or Lynx™), serial and/or parallel.

7. The computer system of claim 1, wherein the dedicated connector supports at least one of ExpressCard™, Universal Serial Bus (USB), Advanced Technology Attachment (ATA), Serial Advanced Technology Attachment (SATA or S-ATA), Small Computer Systems Interface (SCSI), IEEE-1394 (such as, but not limited to Firewire™, i.link™ or Lynx™), serial and/or parallel.

8. The computer system of claim 1, further comprising:
a processor.

9. The computer system of claim 1, further comprising:
a wireless local area network module and/or a display.

10. An apparatus comprising:
a dedicated connector to couple a primary storage and a secondary storage to a bus, the dedicated connector including a logic that identifies a secondary storage, wherein the secondary storage includes information to be transferred to a primary storage, receives a read/write operation targeted to the primary storage, and transmits the read/write operation and the information to the primary storage; and
a multiplexer to couple the primary storage to the dedicated connector.

11. The apparatus of claim 10, wherein the dedicated connector includes a bus conversion module to perform the logic.

12. The apparatus of claim 10, wherein power to operate the dedicated connector and the multiplexer is transferred from a bus device to the dedicated connector.

13. The apparatus of claim 12, wherein the bus device includes the secondary storage.

14. The apparatus of claim 12, wherein the bus device employs at least one of ExpressCard™, Universal Serial Bus (USB), Advanced Technology Attachment (ATA), Serial Advanced Technology Attachment (SATA or S-ATA), Small Computer Systems Interface (SCSI), IEEE-1394 (such as, but not limited to Firewire™, i.link™ or Lynx™), serial and/or parallel.

15. The apparatus of claim 10, wherein the dedicated connector supports at least one of ExpressCard™, Universal Serial Bus (USB), Advanced Technology Attachment (ATA), Serial Advanced Technology Attachment (SATA or S-ATA), Small Computer Systems Interface (SCSI), IEEE-1394 (such as, but not limited to Firewire™, i.link™ or Lynx™), serial and/or parallel.

16. A method comprising:
identifying a primary storage, wherein the primary storage is to receive information to be transferred from a secondary storage;
receiving a read/write operation targeted to the primary storage; and
transmitting the read/write operation and the information to the primary storage.

17. The method of claim 16, further comprising:
verifying the read/write operation was received and the information transferred to the primary storage.

18. The method of claim 16, wherein the identifying of the secondary storage further includes activating a dedicated connector with a bus device, activating a multiplexer to select the primary storage, and reporting the selection of the primary storage to the dedicated connector.

19. The method of claim 18, wherein the receiving and transmitting of the read/write operation further includes activating the secondary storage a bus device, determining the information to transmit to the primary storage, and constructing a read/write operation to transfer the information to the primary storage.

20. The method of claim 18, wherein the bus device employs at least one of ExpressCard™, Universal Serial Bus (USB), Advanced Technology Attachment (ATA), Serial Advanced Technology Attachment (SATA or S-ATA), Small Computer Systems Interface (SCSI), IEEE-1394 (such as, but not limited to Firewire™, i.link™ or Lynx™), serial and/or parallel.

21. The method of claim 18, wherein the dedicated connector supports at least one of ExpressCard™, Universal Serial Bus (USB), Advanced Technology Attachment (ATA), Serial Advanced Technology Attachment (SATA or S-ATA), Small Computer Systems Interface (SCSI), IEEE-1394 (such as, but not limited to Firewire™, i.link™ or Lynx™), serial and/or parallel.
